(19) United States
(12) Patent Application Publication
(10) Pub. No.: US 2009/0123762 A1
(43) Pub. Date: May 14, 2009

(54) Photochromic Adhesive

(76) Inventor: Ronald C. Wiand, Troy, MI (US)

Correspondence Address: RONALD L. HOFER, 122 LINDBERGH LANE, MOORESVILLE, NC, 28117, US

(21) Appl. No.: 11/883,865

(22) PCT Filed: Feb. 7, 2006
(86) PCT No.: PCT/US06/04043

§ 371 Date: Aug. 7, 2007

Related U.S. Application Data
(60) Provisional application No. 60/651,135, filed on Feb. 8, 2005.

(51) Int. Cl. B32B 17/06

(52) U.S. Cl. 428/426; 156/99

(57) ABSTRACT

A laminate has two layers of glass which are bonded together by a monomelic adhesive containing an effective amount of a photochromic moiety.

### BACKGROUND OF THE INVENTION

The present invention relates to transparent or semi-transparent laminates of glass having a photochromic feature. More specifically, the present invention relates to transparent or semi-transparent laminates of glass wherein an adhesive comprising a photochromic moiety bonds the glass layers together.

Tinted glass is often useful in the automotive, building and other industries. Tinting of optical lenses is also useful and, in some cases, it is known to tint optical lenses with a photochromic moiety to provide a lens, which changes tint in response to sunlight or uv light. While it is common to tint glass to provide some protection against bright sunlight and/or uv light, it is not well known to provide large scale photochromic glass. This may be due to the relatively high cost of photochromic moieties or other processing problems or perhaps to the longevity expected of photochromic moieties in use. However, whatever the reason, it would be useful and beneficial if a photochromic glass laminate could be provided which was both effective and economical.

The present invention relates to a method and product in which glass sheets are bonded together with an adhesive which contains a photochromic moiety. The photochromic containing adhesive imparts a photochromic nature to the laminate. Although tinted glass has become popular and is well known throughout the world, it would be highly desirable for some uses to have tinted glass which changes tint in response to the amount of sunlight or uv light exposure. Glass windows or panes often suffer from the disadvantage that the windows are consistently tinted during both day and night. Tinted windows may interfere with visibility during hours of darkness. Thus, it bright sunshine and yet not tinted during hours of darkness, at least not to an extent that would interfere with good visibility.

Photochromic tinting offers one method for providing tinting in bright sunshine but not in the dark. However, photochromic tinting encounters some of its own problems. One problem is that the life of photochromic moieties is relatively short and may not be suited for uses which require relatively long life cycles. Another problem is that the photochromic moieties must be provided in a matrix which is suitable for the intended end use. For example, in some cases a tint may be required to have a fast change of state and in other cases a slow change of state may be acceptable. In most cases, however, it would be desirable to have a photochromic moiety which is carried in a matrix which facilitates relatively long life for the moiety.

Further understanding of the present invention will be had from the following specification taken in conjunction with the accompanying drawings.

### SUMMARY OF THE INVENTION

A preferred embodiment of the invention is a laminate having two glass layers which are bonded together by a monomeric adhesive which comprises an effective amount of a photochromic moiety. In a further preferred embodiment of the invention, at least one facing surface of the glass layers is has a roughened surface as would be obtained by sandblasting it and the monomeric adhesive has a refractive index which is substantially the same as the glass.

### BRIEF DESCRIPTION OF THE DRAWINGS

FIG. 1 is a somewhat schematic view illustrating a preferred method of making the laminate of the present invention.

### DESCRIPTION OF THE PREFERRED EMBODIMENTS

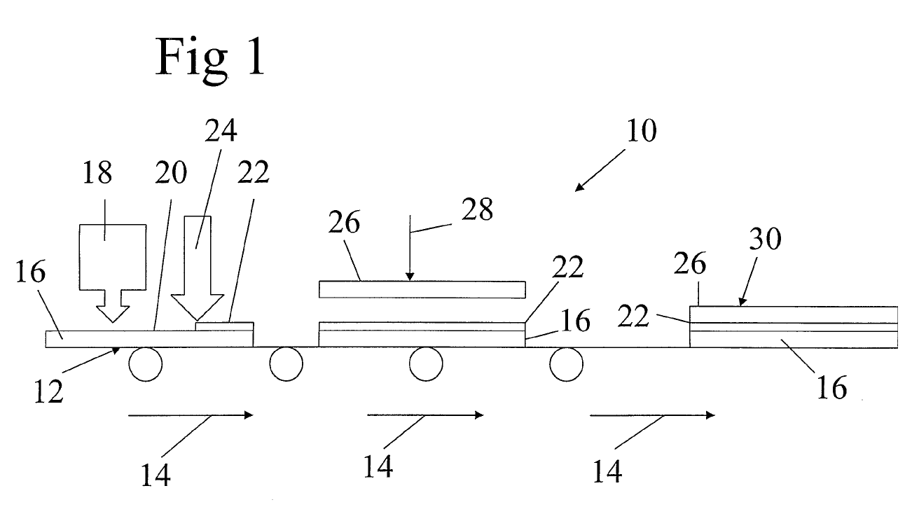

Now referring to FIG. 1, a preferred method of making a laminate of the present invention is illustrated and indicated generally by the numeral 10. Method 10 illustrates use of a conveyor belt 12, which is shown as moving in the direction indicated by arrow 14, i.e., from left to right as viewed in the FIGURE. As sheets of glass 16 pass under sandblasting apparatus 18 the upwardly facing surface 20 thereof is roughened by a conventional sandblasting step. Then a layer of monomeric adhesive 22 is coated onto surface 20 of glass sheet 16 by extruder 24. Next a second sheet of glass 26 is moved downwardly as indicated by arrow 28 and brought into contact with surface 20 of glass sheet 16 and bonded thereto to form laminate 30.

It is contemplated that monomeric adhesive layer 22 will comprise an effective amount of a photochromic moiety. Furthermore, it is preferred that monomeric adhesive 22 is selected to have substantially the same refractive index as glass sheets 22 so that the laminate 30 will appear to be a single homogeneous sheet of glass.

as the glass is suitable for its intended end use. Automotive glasses are especially contemplated for use herein.

Suitable adhesives for use herein are optical adhesives with a refractive index substantially the same as the sheets of glass bonded thereby. Preferably the adhesive is a monomeric adhesive which class of adhesives have been found preferable as carriers for the photochromic moiety. An example of an adhesive which is suitable for use herein is Norland Adhesive NAO 76 uv cured optical monomer adhesive.

Suitable photochromic moieties are well-known in the art and include those selected from the group consisting of anthraquinones, naphtopyrans, phhalocyanines, spiro-oxazines, chromenes, pyrans including spiro-pyrans and fulgides. Suitable photochromic molecules include but are not limited to those disclosed in U.S. Pat. No. 5,882,556 Mar. 16, 1999 to Perrott et al. which is specifically incorporated by reference herein. Reversacl photochromic dyes commercially available from James Robinson are particularly suitable for use herein. In addition to photochromic molecules, the photochromic composition may include a non-photochromic dye if it is desired to provide a tint to the lens even when the photochromic molecules are not activated.

It has been found that a limited amount of ultraviolet (uv) absorbers, light stabilizers such as hindered amine light stablilizers, antioxidants, and or free radical inhibitors may also be included in the adhesive layer. The use of uv absorbers should be limited to some extent because they tend to have a detrimental effect on the life of the photochromic moiety. On the other hand, free radical inhibitors have a beneficial effect on the life of the photochromic moiety.

3052, 3055, 3056 from Sandoz/Clariant, Tinuvin 770, 765, 144, 622 from Ciba Geigy, Cyasorb 3346 from American Cyanamid. Examples of antioxidants include Irganox 3114 from Ciba Geigy.

Suitable uv absorbers work by absorbing ultraviolet radiation and converting the radiation into thermal energy through tautomerism. Of course, the selected uv absorber must not substantially absorb the range of uv light required to activate the photochromic moiety. Examples of suitable uv absorbers include Cyasorb VV-9 and UV 531, Cyaguard UV 1164 and 1084 from American Cyanamid, Sanduvor VSU from Sandoz/Clariant, Uvinul 3035 from BASF, Tinuvin 328 and P and Irgastab 2002 from Ciba Geigy, Rylex NBC from Dupont, UV Chek AM 101, 105, 126, and 205 from Ferro Corp and Carstab 700 from Morton International.

Further understanding of the present invention will be had from the following example.

### EXAMPLE 1

10 g of Norland Adhesive NAO 76 uv cured optical monomer adhesive is mixed with a mixture of 2% acetone, a photochromic dye (KeyStone Plum Red), and 0.1% of irganox 1076. The mixture is then used to bond two sheets of tempered glass to form a laminate. The laminate is then exposed to uv light to cure the adhesive. Then the laminate is a shatter proof laminate that turns a brilliant purple color when exposed to uv light.

1. A laminate having two glass layers which are bonded together by a monomeric adhesive comprising an effective amount of a photochromic moiety.

2. The laminate of claim 1 wherein said monomeric adhesive has substantially the same refractive index as said glass layers.

3. The laminate of claim 1 wherein said monomeric adhesive is an optical adhesive.

4. The laminate of claim 1 in association with an automobile.

5. The laminate of claim 1 wherein said laminate comprises a non-photochromic dye.

6. A method of making a laminate having two glass layers which are bonded together by a monomeric adhesive, said method comprising the steps of:
sandblasting a first surface of a first sheet of glass to roughen said first surface thereof;
sandblasting a second surface of a second sheet of glass to roughen said second surface thereof;
coating a layer of monomeric adhesive comprising an effective amount of a photochromic moiety on said first surface;
coating a layer of monomeric adhesive on said second surface; and
bringing said first and second coatings together in bonding relationship to thereby form a laminate of said first and second glass sheets.

7. The method of claim 6 wherein said monomeric adhesive on said second surface comprises a photochromic moiety.

8. The method of claim 6 wherein said monomeric adhesive has substantially the same refractive index as said glass layers.

9. The method of claim 6 wherein said monomeric adhesive is an optical adhesive.

4. The method of claim 6 including an additional step of installing said laminate on an automobile.

5. The method of claim 6 wherein said laminate comprises a non-photochromic dye.
